(19) United States
(12) Patent Application Publication
(10) Pub. No.: US 2020/0143655 A1
(43) Pub. Date: May 7, 2020

(54) SMART ACTIVITIES MONITORING (SAM) PROCESSING OF DATA

(71) Applicant: iEldra Inc., Broomfield, CO (US)

(72) Inventors: John Neil GRAY, Red Lodge, MT (US); Kevin ALCOX, Littleton, CO (US); David J. KROSEL, Brampton (CA); Thomas PRIORE, JR., Jim Thorpe, PA (US)

(21) Appl. No.: 16/258,028

(22) Filed: Jan. 25, 2019

Related U.S. Application Data
(60) Provisional application No. 62/756,572, filed on Nov. 6, 2018.

(51) Int. Cl. G08B 21/04; G08B 21/18; G08B 25/00; G08B 27/00; G06N 20/00

(52) U.S. Cl. CPC G08B 21/0423; G08B 21/0469; G06N 20/00; G08B 25/005; G08B 27/006; G08B 21/182

(57) ABSTRACT

A comprehensive, secure cloud computing-based system for monitoring and managing personal wellness by employing unobtrusive wireless sensors to track the activities of daily living (ADLs) of a person in their premises and positively engage remote support when care plan deviations are detected, via a variety of communications methods.

### CROSS-REFERENCE TO RELATED APPLICATIONS

The present application claims the benefit of U.S. Provisional Application Ser. No. 62/756,572; Attorney's Docket No. INT-2 PROV, entitled SMART ACTIVITIES MONITORING (SAM) PROCESSING OF DATA, which was filed on Nov. 6, 2018.

### TECHNICAL FIELD

The present invention relates to systems and methods for monitoring and measuring the health and well-being of independent living and aging adults. More specifically, the present invention relates to a secure, comprehensive, cloud-based system to manage personal wellness and adjust routine parameters using machine learning.

### BACKGROUND

With the 65+ population exploding with 10,000 new retirees joining them a day and “Aging in the Home” a priority, there is an increasing popularity among seniors, their caregivers and family members to sign seniors up for health and wellness monitoring in the home.

There is a need for a system and method for dynamically measuring and monitoring subscribers' activities in their living spaces. A system and method are needed to determine the subscriber's well-being, based on physical and cognitive factors, analyze the responses and activities and activate a call list to alert the subscriber's caregivers. A system and method are needed that can use machine learning or artificial intelligence to adjust the standard routine of the subscriber and adjust the thresholds for alerting caregivers to the well-being of the subscriber. A system and method are needed that includes a voice assistant that can actively initiate audio or communication into the living space of the subscriber to communicate with the subscriber to determine and analyze the subscriber's well-being.

### SUMMARY OF THE INVENTION

The various systems and methods of the present invention have been developed in response to the present state of the art, and in particular, in response to the problems and needs in the art that have not yet been fully solved by currently available health and well-being monitoring systems. The systems and methods of the present invention may provide a secure and comprehensive system and method for measuring and monitoring the health, well-being, and daily activities of persons, further being able to actively adjust certain thresholds for engaging the person or alerting other users, such as loved ones and caregivers.

Smart Activity Monitoring (SAM) platform solution that provides peace of mind to families by enhancing the “Aging at Home” experience with an economical and comprehensive, free-living activity monitoring solution that uses unobtrusive sensors to track, measure, and assess Activities of Daily Living (ADL) and Instrumental Activities of Daily Living (IADL) of a subscriber and includes timely human acknowledgement, interaction, and resolution through a caregiver network which may include a 24/7 Customer Care Center. Older adults need to celebrate their independence, not compromise it. They thrive on being free and living independently, so sharing how they are taking good care helps deepen the connection they want and need. Older adults say they are better off staying in their homes. When one has built a home and become part of a community, the last thing an adult wants to do is leave it. Adult children have assumed the burden of caring for their parents, but still have the responsibility of their own families. A system and method that allows an older adult to stay in their home and maintain a level of independence yet creates a safety net and means for caregivers to actively care for the aging adult may revolutionize the well-being of older adults. With 46 million seniors living alone in America and 90% wanting to stay in their homes, SAM was created specifically with the “Aging in Place” market in mind.

To achieve the foregoing, and in accordance with the invention as embodied and broadly described herein, and given the need for an improved system and method for monitoring and measuring a subscribers well-being, this disclosure encompasses improved systems and methods. In accordance with this disclosure, a cloud-based activities measuring and monitoring system for the health and well-being of a subscriber comprises a platform, an engagement web in communication with the platform. The engagement web further comprises at least one sensor and at least one interactive health and well-being assistant. The system further comprises an off-site cloud computing network in communication with the platform and configured to analyze data from the platform and other external courses. The at least one sensor is configured to collect event data and communicate the even t data with the platform. The at least one interactive health and well-being assistant is configured to engage with the subscriber and is configured for two-way communication. The platform further comprises an HTTPS-based interface to send and receive data to the cloud computing network. The event data includes activities of the subscriber such as in categories like physical, social, cognitive, emotional, and environmental. The engagement web is remotely activatable by a secondary party, which creates a multi-way link between the subscriber and a secondary party. The secondary party may be a caregiver, a health care provider, payor, or another interested party. The at least one assistant comprises a microphone and a speaker. The speaker is remotely and locally initiatable.

In accordance with the disclosure, a method of measuring and monitoring the health and well-being of a subscriber comprises distributing an engagement web in a living space. The engagement web comprises at least one sensor and at least one interactive health and well-being assistant having means for two-way communication and comprising a microphone and a speaker. The at least one sensor is configured to track an event having an alert threshold. The at least one sensor is in communication with the at least one assistant distributed in the living space. The event data is relative to the alert threshold of the event. The method further comprises connecting the engagement web to a platform within the living space wherein the at least one sensor securely communicates event data to the platform. The platform provides local infrastructure management and event data caching and securely communicates the event data from the platform to a cloud-based operational support system. The operation support system comprises a machine learning process running on a machine readable medium. The machine learning process compares the event data against the alert threshold and determines whether the event data exceeds the alert threshold and if the event data exceeds the alert threshold, an alert is activated. If an alert is activated, the machine learning process communicates the alert to a user and wherein the alert is further communicated to a call tree. The alert threshold comprises a plurality of thresholds. The user may be selected from the group including the subscriber, a caregiver, a healthcare provider, a payor, or an interested third party. The alert threshold is adjustable by the operational support system as a result of the machine learning process, as well as the user. The user is a subscriber in the living space and if an alert is activated and communicated to the subscriber, the at least one health and well-being assistant relays a communication message into the living space. The communication requires a response. The communication method may be relayed over a land-line, a cell phone, or the at least one interactive health and well-being assistant. If the at least one interactive health and well-being assistant does not detect an appropriate response, the operational support system sends a second communication message to another user. The machine learning process uses the response to analyze the well-being of the subscriber. The alert also may be communicated to a call tree, which is adjustable by the subscriber or another user. The method further comprises determining a routine of a subscriber and creating a baseline of activity. The operational support system creates and adjusts the baseline of activity in response to variations in the subscriber's routine. The operational support system sets and adjusts the event threshold with predictive analysis.

In accordance with the disclosure, a tangible non-transitory computer readable storage medium having instructions stored thereon that, when executed by a computing device, causes the computing device to perform operations comprising receiving event data from a user in a living space based at least in part on information regarding the living space. The event data is based on data collected from at least one sensor in the living space. The storage medium causes the computing device to analyze the event data and compare it to positive and negative thresholds for the user's well-being, which are stored in an event database. The medium causes the computing device to determine if the user's well-being has a positive state or a negative state. If the user has a negative state, the medium causes the computing device to initiate a communication with the use with at least one health and well-being assistant, receive a response from the user via the assistant, analyze voice characteristics of the user based on the response and initiate a call tree to communicate with secondary users. If no response is received from the user, a call tree is initiated to communicate with secondary users.

These and other features and advantages of the present invention will become more fully apparent from the following description and appended claims, or may be learned by the practice of the invention as set forth hereinafter.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a schematic view of a monitoring system according to one embodiment of the invention.

FIG. 2 is a schematic view of an interface pathway, including call tree activation, of the monitoring system according to one embodiment of the invention.

FIG. 3 is a schematic view of an interface pathway, including interaction with the subscriber, of the SAM Voice Assistant according to one embodiment of the invention.

### DETAILED DESCRIPTION

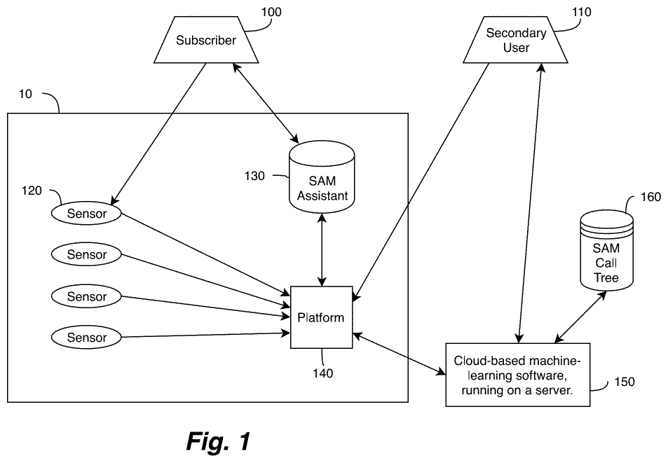

Exemplary embodiments of the invention will be best understood by reference to the drawings, wherein like parts are designated by like numerals throughout. It will be readily understood that the components of the invention, as generally described and illustrated in the Figures herein, could be arranged and designed in a wide variety of different configurations. Thus, the following more detailed description of the embodiments of the apparatus, system, and method, as represented in FIGS. 1 through 3, is not intended to limit the scope of the invention, as claimed, but is merely representative exemplary of exemplary embodiments of the invention.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature is able to pass into the other feature.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles of the invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

Activities of Daily Living are routine activities that people tend do every day without needing assistance. There are six basic ADLs: eating, bathing, dressing, toileting, transferring (walking) and continence and several others that contribute to the ability for a person to live independently. The performance of these ADLs is important for determining what type of long-term care is required. The commonly accepted activities of daily living are listed in the Roper-Logan-Tierney Model of Nursing (RLT). There are also Instrumental Activities of Daily Living (IADL) defined by Lawton & Brody (Lawton M P, Brody E M. Assessment of Older People—Self-maintaining and Instrumental Activities of Daily Living. Gerontologist 1969;9(3):179-86.). The IADLs are a more complex measure of a person's ability to live independently.

The system is generally comprised of on-premise Internet of Things (IoT) sensors and a custom voice assistant configured to identify ADL event occurrences, assess IADL and ADI competency, provide 2-way audio or physical communications and securely communicate event attributes to a premise gateway. The premise gateway provides local infrastructure management, event data caching and secured event data transport to a cloud-based operational support system (OSS). The secured OSS includes machine learning to automatically configure and optimize the ADL event monitoring algorithms, sensor configuration actions, and IADL assessment actions. A variety of modern communications methods are utilized to engage remote support personnel, in their preferred communication method, in a recursive model to assure an event response.

The computing devices may optionally be connected to each other and/or other resources. Such connections may be wired or wireless, and may be implemented through the use of any known wired or wireless communication standard, including but not limited to Ethernet, 802.11a, 802.11b, 802.11g, and 802.11n, universal serial bus (USB), Bluetooth, cellular, near-field communications (NFC), Bluetooth Smart, Z-wave, ZigBee, and the like. By way of example, wired communications are shown with solid lines and wireless communications are shown with dashed lines.

TABLE 1

| ADL | Source |
|---|---|
| Breathing | RLT |
| Communication | RLT |
| Continence | RLT |
| Controlling body temperature | RLT |
| Dressing | RLT |
| Drinking | RLT |
| Eating | RLT |
| Elimination (Toileting) | RLT |
| Maintaining a safe living environment | RLT |
| Mobilization - Body Movement | RLT |
| Sleeping | RLT |
| Bathing | RLT |
| Working and playing with a sense of purpose | RLT |
| Handling Transportation | Lawton-Brody |
| (driving or navigating public transit) | |
| Housework and Basic Home Maintenance | Lawton-Brody |
| Managing Finances | Lawton-Brody |
| Managing Medications | Lawton-Brody |
| Preparing Meals | Lawton-Brody |
| Shopping | Lawton-Brody |

Modern technology has provided sensors and devices, that when properly configured and deployed within a living space, allow detection of activities that can be interpreted to be fulfillment of an ADL/IADL or the lack of fulfillment of an ADL/IADL. When a sensor is triggered, it creates an event which is wirelessly transferred to a communications platform located on premise. The platform converts the low-energy radio signals from the network nodes into a communications protocol that is capable of transferring the events to a cloud-based computing infrastructure which supports complex algorithmic data analysis and event handling workflow. This entire communication path is secured using a combination of FIPS 140-2 compliant modern cryptography methods such as TLS, RSA-1024 certificates, AES-128, AES-CCM, and ECDH key exchange to produce a unique and highly secure wellness monitoring system. The system may be network agnostic.

The Smart Activities Monitoring (SAM) is built upon the tenet that technology can be leveraged to provide a safety net for those wishing to maintain their independent living lifestyle. The SAM system's second key tenet is that humans will establish a normal and measurable pattern of physical and cognitive behavior, deviations from which indicating areas of concerns for SAM users. In the SAM solution, every independent living person is assigned a custom care plan. That care plan establishes a normal pattern of behavior, defines the thresholds for specific monitorable actions and a set of users. The SAM activity engine receives the raw events and applies a series of care plan rules with their custom thresholds via a machine learning model. This statistical data-to-decision process generates an alert when a deviation from normal is detected and also automatically adjusts the monitoring action thresholds to optimize the alerting to the independent living person's normal patterns.

The alert is fed to a workflow engine that creates the call tree that will iteratively engage the independent living person and their series of remote caregivers via a selectable communication method. Methods supported include SMS text, phone or audio and visual push notifications to a custom SAM voice assistant (independent living individual only). The SAM Voice Assistant also serves as audio sensor in the situation where the independent living person wakes the device in the event of an emergency and establishes a two-way audio communication channel with the call center.

Given the demographics of the target SAM independent living person and based upon the care plan, the graphical user interface, the telephony audio interface and the audio SAM Voice Assistant interface that are interacted with are based upon a minimal set of interactions that are highly usable and accessible. These characteristics are captured in personas and associated scenarios that reflect the patterns and needs of the independent living person.

The system is available to a variety of users. The term “user” may refer to anyone who interacts with, engages with, is subject to, or has control over the system and its components. A user may include the subscriber, which is intended to refer to the person whose health and well-being will be measured and monitored. It is reasonable, in the context of this invention, that the subscriber may be an older adult who intends to live on their own in their own dwelling. Their dwelling may be a home, apartment, or an assisted living complex. The dwelling may be owned or rented by the subscriber. It is also contemplated that the subscriber may be a younger adult with special needs relating to physical or mental health.

The user may also refer to a caregiver. A caregiver may be anyone who has a special relationship with the subscriber. For example, the caregiver may be an adult child of the subscriber. The caregiver may be a sibling or another family member that is tasked with providing oversight, care, or a power of attorney over the subscriber.

The user may also refer to a health care provider. A health care provider may include skilled providers such as a physician, nurse, or other medically trained individual. A health care provider may also include non-skilled individuals such as a home-health aide.

The user may also refer to a payor. A payor may include insurance companies that are responsible for payment of the health care costs of the subscriber. A payor may also include government service providers such as Medicaid, Medicare, or another subsidiary of Health and Human Services, at the Federal level, or another state or local level agency.

The user may also be another interested party. The interested party may include a social worker, clergy, or researcher. It is contemplated that data gathered from the system may be used not only for the health and well-being of the subscriber, but also in a research context.

The system may be comprised of various separate or combined physical elements which are located either in the living space of the adult or remotely.

An important aspect of the present invention is that the system may be customized to the specific needs of the individual and it is therefore important to determine the actual needs and the routine daily activity of the subscriber during a regular day. The subscriber or another user may create specific events to be monitored and measured in order to determine what is the normal routine for the subscriber. For example, the subscriber may know that visiting the toilet 5 times a day is normal. Or, the subscriber may know that bathing once a day is normal. The subscriber or other user may preprogram the OSS to create a baseline of activity with these figures for the event data. A user may create a threshold higher or lower than the baseline, which would trigger an alert.

The operational support system (OSS) also utilizes machine learning or artificial intelligence to determine a subscriber's daily routine and what events are considered normal and appropriate. That the OSS uses machine learning to determine daily routine is particularly efficacious if the individual is suffering from dementia, has a cognitive deficiency, has had a stroke, is handicapped or otherwise is in need of special assistance. With machine learning, the OSS can learn to set the proper thresholds without caregiver interaction. It can continually assess activity and set thresholds appropriately, and it can monitor for long term trends that may not be obvious to the caregivers to add more depth to possible notifications. It can also assess activity patterns across broad populations and use that information to make predictive models of when interventions are needed.

In an embodiment, the SAM system includes at least one engagement web, a least one platform, and a cloud-based machine-learning or artificial intelligence processor (the Operational Support System [OSS]) configured to analyze and respond to event data.

### Engagement Web

Referring to FIG. 1, in one embodiment, the at least one engagement web 10 includes a plurality of sensors 120 located through the living space of the subscriber 100. The sensors 120 are arranged throughout the space to best monitor and measure certain parameters of predetermined ADLs, as suggested in Table 1. These ADLs may also be referred to as “events.” For example, the sensors may include movement sensors that are able to track how much the subscriber moves during the day. The movement sensors may determine whether, and how often, the subscriber walks around the space. The movement sensors can track and measure which rooms the subscriber visits throughout the day. Other sensors contemplated include sensors that can monitor and measure other physical attributes of ADLs, such as frequency of bathroom visits including both elimination and bathing, sleeping patterns, eating habits, and other physical attributes associated with mobile and ambulatory subscribers. For non-mobile subscribers, physical attributes can be monitored and measured such as: breathing, body temperature regulation, and eating habits.

Other embodiments of the sensors 120 and SAM assistant can monitor and measure IADLs, cognitive, and emotional attributes of the subscriber. Cognitive attributes of the subscriber may include personal interaction with others—such as talking on the telephone or using social media. Personal interactions may include having friends over, talking to the postal carrier, or going out for errands, as suggested in Table 1. Cognitive assessments of the subscriber, in the form of a question and answer session, may also be administered by the assistant 130. Examples of suitable questions may be found on the Short Form 36, from the RAND corporation.

Other embodiments of the assistant 130 can prompt the subscriber to participate in an event such as taking medication, weighing oneself, attending a medical appointment, or other personal activity. Additionally, the assistant 130 may connect the subscriber to external health and well-being providers for the purpose of education. For example, a subscriber may ask the assistant for information about burn care, if the subscriber gets burned on a stove. The assistant 130 then may connect the subscriber with an on-call nurse, or other information source.

Other embodiments of the sensors 120 can measure environmental attributes of the living space. Sensors 120 can monitor ambient temperature, noise level (whether the TV is loud), light levels, or air quality (such as smoke or humidity).

The sensors 120 may be battery operated or run on electrical current. The sensors may be hardwired or wireless, as described herein. The sensors 120 may actively monitor the prescribed attribute, or they may rest passively until triggered by an event. The event may be activity or attribute, which the sensors 120 are intended to monitor and measure. For example, a bathroom sensor may be passive until it is activated by a subscriber walking into the bathroom, at which point the bathroom sensor activates and monitors and measures the subscriber's activities in the bathroom. When the subscriber leaves the bathroom, the sensor powers down into a passive mode. Alternatively, for a non-ambulatory subscriber, a breathing sensor may always remain active. The sensors 120 may track, log, and record data about events and communicate that data to the platform. In another embodiment, the sensors 120 may communicate directly with either the SAM voice assistant 130 and/or the Operational Support System (OSS.) The sensors 120 are interconnected, or otherwise coupled, to other sensors 120, to the platform, the cloud-based machine learning processor (OSS), and to a SAM assistant.

The engagement web may also include at least one SAM assistant 130 (“assistant”). The assistant can be combined in a housing with one or all of the sensors 120, or it can be a stand-alone device. The assistant is intended and operable to directly interact with the subscriber via a communication. In one embodiment, the assistant includes a speaker and a microphone. The assistant is capable of relaying a communication to the subscriber via an audible or voice message through the speaker and receiving an audible or voice message from the subscriber via the microphone. In one embodiment the engagement web includes a plurality of assistants spread through the living space, so that all areas in the living space can receive a communication from the assistant. For a subscriber with a large living space, multiple assistants through the space ensure that the subscriber is not out of communication with the assistant or the engagement web. The assistant may include other means of communication to interact with the subscriber. Other means of communication in combination with, or instead of, the speaker may include lights or other visual stimuli, vibrations, or tactile or haptic stimuli. To receive communication from the subscriber, the assistant may use a microphone to pick up verbal or other audible responses from the subscriber. Other means of communication in combination with, or instead of the microphone may include a camera (visual or non-visual/IR spectra), a graphical user interface (GUI), or other tactile or haptic receivers. Non-audible means of communication may be suitable for subscribers that are deaf or have a hearing impairment. Non-visual means of communication may be suitable for subscribers who are blind or have a visual impairment.

In an embodiment, the SAM assistant 130 may be activated by the subscriber or a secondary user. The subscriber may activate the SAM assistant 130 by voice (via the microphone) or other means (a button or other means), which would connect the subscriber 100 to a secondary user 110. Alternatively, a secondary user may “push-activate” the assistant, which would activate the speaker (or other communication means), in order to prompt a response from the subscriber. For example, if the overall system does not detect any motion or register certain ADL events in a given timeframe, a secondary user may push-activate the assistant to check on the status and well-being of the subscriber. In an exemplary scenario, a subscriber may have fallen and suffered an injury which prohibits the user from reaching the telephone. If the sensors 120 do not detect movement appropriate for the subscriber's normal routine, a secondary user or the automated OSS may push-active the assistant, which would then activate the speaker, calling out for the subscriber. The subscriber could then respond and speak directly to the system, confirming that the subscriber is in a healthy condition, or if the subscriber requires assistance. The SAM assistant 130 may also have short-cut features that may be voice-activate or touch-activated. For example, the assistant may have a HOME or AWAY button that sets the system to a predetermined state of awareness. If the subscriber leaves the living space, the subscriber may choose to set the system to “away” in order to prevent false alerts to the system. The SAM assistant may also have a microphone mute button that enables or disables the microphone. The engagement web 10 may enter into a power-saving mode. Additionally, the assistant may have a button that prompts an immediate emergency call, without having to dial numbers or contact another party. The assistant may be interconnected, or otherwise coupled, to other assistants, to the platform, the cloud-based machine learning processor (OSS), and to the at least one sensor.

### Platform

The platform is an intermediary device that handles communications between the elements in the engagement web 10 and the OSS. The platform may operate as a short-range wireless protocol optimized for reliable, low-latency communications of small data packets. The short-range wireless protocol may be Z-Wave. The platform receives data from the sensors 120 and the assistant 130. The platform may be capable of processing the data and determining if a response to that data is necessary, or the platform may communicate the data to the OSS, so that the OSS can perform the analysis.

Communications between the various elements of FIG. 1 may be routed and/or otherwise facilitated through the use of routers. The routers may be of any type known in the art and may be designed for wired and/or wireless communications through any known communications standard including but not limited to those listed above.

The routers may facilitate communications between the computing devices and one or more networks, which may include any type of networks including but not limited to local area networks such as a local area network, and wide area networks such as a wide area network 144. In one example, the local area network may be a network that services an entity such as a business, non-profit entity, government organization, or the like. The wide area network may provide communications for multiple entities and/or individuals, and in some embodiments, may be the Internet. The local area network may communicate with the wide area network. If desired, one or more routers or other devices may be used to facilitate such communication.

### Operational Support System (OSS)

The OSS 150 is configured to receive and analyze event data gathered from the sensors 120, and optionally the SAM Voice Assistant 130, in the subscriber's living space as well as any external data sources. The OSS 150 is really intended to establish a pattern of normalcy and then alert any deviations from that baseline that violate thresholds established as part of the overall care plan. A second feature of the OSS 150 is to establish long-term health and well-being trends and alert users when those trends show a decline in ADL/IADL fulfillment. A third feature of the OSS 150 is to guide the repetitive and non-subjective administration of cognitive tests. A fourth feature of the OSS 150 is to self-manage the infrastructure and alert the users and call center in the event of an impairment or failure of the SAM platform. A fifth feature of the OSS 150 is to ingest and organize external party data used to enhance the sensor 120 and SAM Assistant 130 data. A sixth feature of the OSS 150 is to provision the SAM platform. A seventh feature of the OSS 150 is to provide SAM platform usage input to a billing system.

The OSS may be based on a remote or cloud-based computer server managed and supported by a vendor. The OSS may embody a computer program product having program code means that are stored in memory on a non-transitory computer-readable data carrier, for performing one or more of the aforementioned steps when the program code means is executed on the processor or like processing unit. The OSS processes the sensor data to monitor and analyze the subscriber's activities and determine whether the subscriber is safely within a threshold determined by a user or from the OSS machine learning. The OSS can be pre-program with specific thresholds for a subscriber's activities. For example, a caregiver may determine that the subscriber's healthy/normal routine include 5 trips to the bathroom per day. The caregiver may program an upper threshold of 7 bathroom trips and a lower threshold of 3 bathroom trips per day. If the sensors 120 detect activities beyond the thresholds, the OSS creates an alert for the subscriber, the user, or the call tree 160. However, the OSS may also create thresholds for activities based on a review period, for example of two weeks, whereby the subscriber goes about a normal daily routine. After observation, via the sensors, for the review period, the OSS uses machine learning (or artificial intelligence) to create what may be a normal routine for the subscriber.

### Method for Activating Call Tree

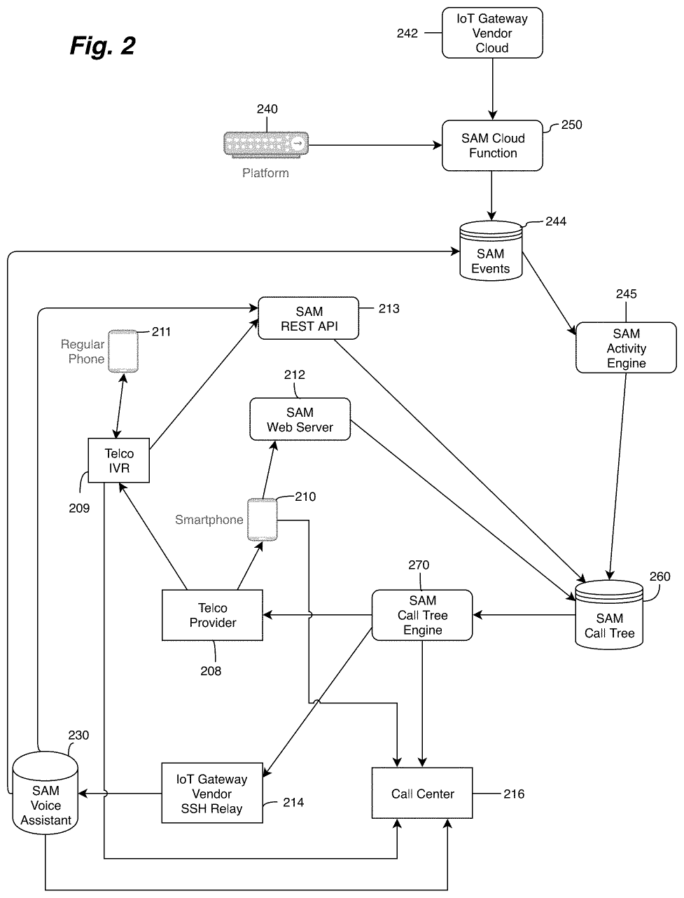

Referring to FIG. 2, a method is schematically depicted showing how the system alerts users to a potential problem with the subscriber. The method includes a platform, at least one sensor, at least one SAM voice assistant 230, and an Operational Support System. In one embodiment, the system monitors and measures events of a subscriber. In the embodiment, thresholds for events have been determined, either by a user or by the OSS after a review period. If the system measures an event and the associated data is beyond a threshold, an alert is created and the system begins a process or method to alert the subscriber or another user of the alert. The method then utilizes a call tree 260 to distribute the alert to the appropriate users.

The Call Tree 260 is a generated schedule within the database for each alert. It details who to contact (a user or “contact”), the method to contact them and when to contact them. The Call Tree not only consolidates the contact protocols but also stores the history of the initiated contacts and their responses:
1) When the contacted received the message by, for example, SMS or IVR or SAM Voice Assistant
2) When the contact viewed the message. For example, clicking on a URL on a SMS text.
3) When the contact performed an action: OK, INVESTIGATE, AWAY or CALL SAM

The selection of contacts for each Call Tree 260 depends on the type of alert and the contact's options. The contacts can choose to opt-out of certain alerts. The subscriber or caregiver may configure the priority for each contact for the Call Tree and how many minutes to give them before escalating to the next contact.

For certain types of alerts, a Call Center 216 is added as the last contact point on the Call Tree. This is considered an escalation point when no action has been taken by any of the contacts. The Call Center is contacted by creating a support ticket for the agents, working at the call center.

The Call Tree 260 could either start immediately when the alert is generated or wait until the next Start of Day for the subscriber. This will depend on the type of alert and the subscriber's account settings. Once a contact chooses either OK, AWAY or CALL SAM (the call center), the remaining scheduled calls, from the Call Tree will be cancelled.

TABLE 2
Call Tree Examples

| Step | Contact's Action | Result |
|---|---|---|
| SMS to Contact #1 | Ignored | Go to next contact |
| Outbound IVR to Contact #2 | Picked up Call | Close alert |
| | Pressed “OK” | Cancel remaining |
| | | schedule |
| [symbol] | | Cancelled |
| [symbol] | | Cancelled |
| [symbol] | | Cancelled |
| SMS to Contact #1 | Ignored | Go to next contact |
| SMS to Contact #2 | Viewed the | Go to next contact |
| | alert | |
| SMS to Contact #3 | Ignored | Go to next contact |
| Call Center | | New ticket created |
| | | for call center agents |

When the contacts receive an SMS alert, it may include a URL that points to a web page on a SAM web Server. The web page will provide all details of the alert, and provide the necessary options for the alert:
1) Everything is OK
2) Investigate. This will push the remaining schedules by 15-minutes.
3) Call the Call Center 216
4) Put the subscriber's account into AWAY mode. The customer will be prompted to enter the number of hours or days away. This is an option if the subscriber is with the contact, and is aware that the subscriber is not at home or in the living space.

The Example in FIG. 2 picks up after the system in FIG. 1 has been placed in the subscriber's living space. The engagement web 10 has been deployed and sensors 120 have been established through the living space. At least one SAM voice assistant 130 has been placed in the living space. The assistant 130 and the sensors 120 are connected and in communication with the platform 140/240. The platform 140/240 has been established and is online and is in communication with the OSS 150. The Subscriber 100 can manage the engagement web 10 by placing the web 10 into a HOME or AWAY state. If an active subscriber leaves the house, the subscriber can put the web 10 into AWAY mode, which deactivates a majority of the alerts and may put the equipment into a power saving mode. When the subscriber is home, the web 10 is placed in HOME mode. In HOME mode, the sensors 120 are actively or passively monitoring and measuring events from the event data. Event data are sent from the sensors 120, and optionally from the SAM Voice Assistant 130, to the platform 140/240 which send events directly to the SAM Cloud function or OSS 150/250. The event data are sent from the platform 240 to the OSS 150/250 via an internet connection or other vendor service 242.

When received by the OSS 150/250, event data is stored in the SAM Events database 244. The SAM Activity Engine 245 continuously scans the latest event data to determine if an alert is required. If the subscriber is in AWAY mode, only events related to environmental factors or service outages are reviewed. The engine 245 compares the event data with predetermined thresholds for each event. The engine 245 may also create derived alerts based updated Subscriber 100 behavior. The engine 245 may use artificial intelligence to analyze behavior and adjust the threshold for alerts based on real-time data. For example, if a Subscriber cancels an alert more than a couple times, the engine 245 may create a derived alert which will, in essence, override the subscriber's 10 veto. This feature is in intended for subscribers 10 who may not want to bother a caregiver or other user or may be embarrassed to request help. For example, a subscriber may not recognize that an increase in bathroom visits and events may be a result of an underlying disease state, such as a urinary tract infection. However, a caregiver or secondary use should be alerted to the symptoms.

If the sensors 120 have detected event data, which the engine 245 determines breaches a threshold, the engine 245 creates an alert. The alert may be for a specific event, monitored by a specific sensor, or the alert may be a combination of events. When an alert is generated a corresponding Call Tree is created in the SAM Call Tree database 260. Each event may be associated with a unique call tree stored in the SAM Call Tree database 260. The Call Tree database 260 schedules the communications with the necessary users or contacts, previously set up on the subscriber's 10 account.

The SAM call tree engine 270 continuously scans the call tree 260 and processes the next scheduled communication, as shown in Table 2. The call tree engine 270 may use certain software architecture such as REST API. The call tree engine 270 may perform any of the following actions:
1) Trigger the telecommunications company (“telco”) 208 to perform an outbound SMS to a contact
2) Trigger the telecommunications company (“telco”) 208 to perform an outbound call via IVR 209 to a contact
3) Trigger the SAM voice assistant 130 to communicate with the subscriber 10
4) Create a support ticket for an associated call center 216 if there was no action taken by any of the contacts on the call tree

The telco 208 is responsible for any interactive voice responses (IVR), phone calls, or SMS/text messages sent to the subscriber or other contacts. The telco IVR 209 performs the outbound calls to the contacts. If there is no answer, no action is taken, the Call Tree Engine 270 will then escalate with the next contact in the Call Tree. IVR scripts may perform REST API calls to SAM REST API engine 213 to update the Call Tree 260 based on the responses received from the contact.

The contact may receive an SMS Text message on a smartphone 210, with a URL that will redirect to the SAM Web Application 212 to view the alert details. The contact is given the following options:
1) Everything OK
2) Need to investigate, which will push the remaining schedules on the Call Tree by 15-minutes
3) Call the Support Call Center 216
4) Put the subscriber's account into AWAY mode. The customer will be prompted to enter the number of hours or days away. This is an option if the subscriber is with the contact and is aware that the subscriber is not at home or in the living space.

The contact may receive the call 211 from the IVR. The contacted person will hear an alert message describing the event and will be prompted to choose one of the following options:
1) Everything is OK
2) Need to investigate, which will push the remaining schedules on the Call Tree by 15-minutes
3) Transfer call to the support Call Center 216
4) Put the subscriber's account into AWAY mode. The customer will be prompted to enter the number of hours away. This is an option if the subscriber is with the contact and is aware that the subscriber is not at home or in the living space.

The SAM Web Application 212 updates the Call Tree 260 information based on the responses received from the contact. The SAM Voice sends REST API commands to the SAM REST API Server 213 to update the Call Tree based on the responses received from the contact. Using a vendor's SSH Relay 214, a REST API is sent via the relay to the SAM voice assistant 230. The SAM voice assistant 230 is uniquely identified by serial number. The IP Address of the SAM voice assistant 230 is provided by the “Ping” commands it sends to the SAM Cloud Function OSS 250. The SAM voice assistant 230 receives the REST API command and starts the audio script. The SAM voice assistant 230 will send REST API commands to store all interactions with the contact.

When the support call center 216 is notified, it will receive 1) support tickets created by the SAM call tree engine 270, 2) inbound transfers from the telco IVR 209, and 3) inbound calls from the smartphone's 210 “call SAM” prompt from the web app 212.

### Method for Activating the Sam Voice Assistant

It is important to be able to proactively contact the subscriber 10 especially in potential medical emergencies. In a situation where alerts have been triggered, but the secondary users or contacts are unable to directly contact the subscriber 10, via telephone or smart phone, it is beneficial to open up a line of communication directly in the living space. The present invention anticipates this scenario and provides a method for contacting or communicating with the subscriber via voice, a physical button, or other means of communication discussed above.

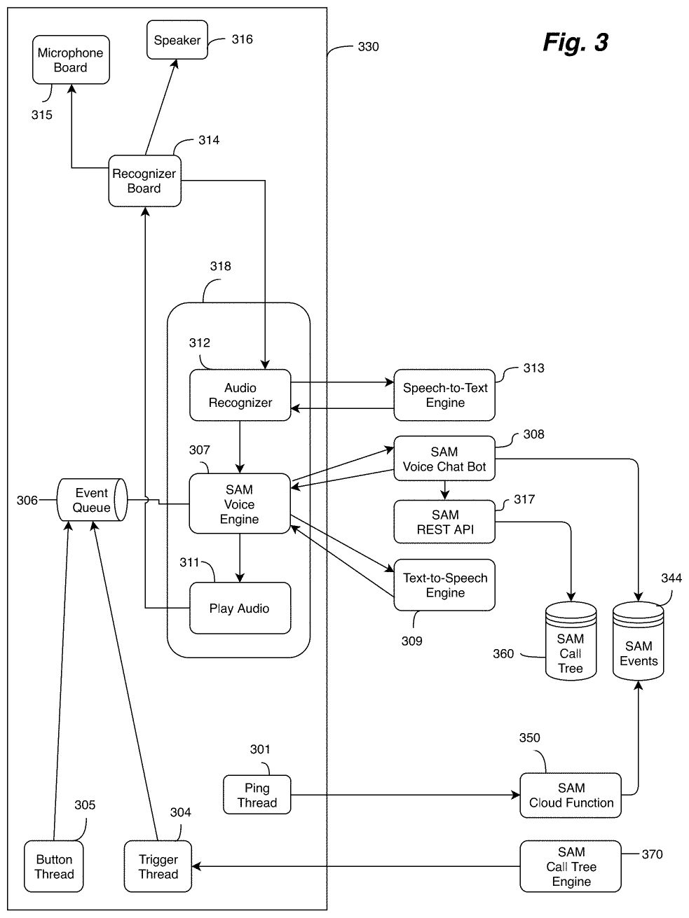

Referring to FIG. 3, the SAM voice assistant 130/230/330 creates a ping thread 301 that will send a REST API command ping to the SAM Cloud Function or OSS 150/250/350, with the serial number and current IP Address of the assistant 330. This information identifies the assistant and the subscriber 10. This information is stored in SAM's cloud-based Events database 344. The IP Address will be used by the SAM call tree engine 370 to send triggers back to the SAM voice assistant 330. The SAM cloud function 350 will receive all ping events from all SAM voice assistants 330.

The SAM call tree engine 370 sends a REST API Command to the SAM voice assistant 330 via the trigger thread 304 using the latest IP address from SAM's cloud-based events database 344. The trigger thread 304 will receive the REST API Command from the call tree engine 370 and put the message into the event queue 306. Possible triggers are:
1) There was a SAM alert and there is a need to contact the subscriber 10 to see if that person is alright
2) Movement has been detected at home but the subscriber's account is currently set to AWAY mode. The appropriate action is to speak out (via SAM Voice Assistant 230) to the house to confirm if the subscriber has come back home. If the subscriber is home, then automatically change the account back to HOME mode.

When the user presses the button 305 on top of the SAM voice assistant 230/330, a message is put into the event queue 306. The global event queue 306 will provide first-in-first-out (FIFO) queuing of events for the SAM voice engine 307 to process. The SAM Voice Engine 307 runs the main flow for SAM Voice Assistant 230/330. It processes events from the queue (FIFO) and then executes the corresponding call flow. The call flow is a process loop with the following steps:
1) Create new session with the SAM voice chat bot 308. The chat bot 308 returns the first announcement text to the subscriber 10, based on the type of trigger (button, alert, etc.) For enhanced security, the SAM voice chat bot 308 will only accept events from SAM Voice Assistants 230/330 that are from the same dwelling that has a registered SAM platform 240.
2) The voice engine 307 will then translate the “text” to an audio data stream using the text-to-speech engine 309. Multiple languages are supported.
3) Play the returned audio data stream 311 to the subscriber.
4) Wait for the response 312 from the subscriber and use speech-to-text engine 313 to translate the audio to text. Multiple languages are supported.
5) Using the same chat bot session, send the translated response text back to the chat bot 308 to determine next steps based on the received text and the current state of the call flow.
6) Chat Bot 308 returns the text to respond back to the subscriber.
7) Loop back to step (2) to wait for a response, or terminate the call flow and process next event in queue

The SAM voice chat bot 308 handles the main business logic and session management for the SAM voice assistant 330. The SAM voice assistant 330 will send the text of what the subscriber said and then return what to say back to the subscriber. The session is used to manage the current state of the call flow and to determine the next actions. The chat bot 308 is responsible for storing all interactions in the SAM events database 344. Due to privacy, only voice events related to SAM are stored in the database 344. The chat bot 308 performs updates to the SAM call tree database 360 with the results based on the subscriber's responses:
1) Everything is OK
2) Back HOME
3) Going AWAY. The SAM Voice will prompt the subscriber to say either “number of hours” or “number of days” away.
4) Contact the Call Center 216 for help

The cloud-based text-to-speech engine 309 receives a text string from the SAM voice engine 307 and returns back a translated LINEAR16 data stream in the language specified in the subscriber's account. Multiple languages are supported. The SAM voice engine 307 receives the LINEAR16 data stream and plays back 311 to the subscriber through the speaker 316 connected to the recognizer board 314. The Audio Recognizer 312 performs the following steps:
1) Waits for audio from the subscriber via the microphone board 315
2) If timeout, return error back to the SAM voice engine 307 to repeat the instructions to the subscriber. If multiple timeouts, then the SAM voice engine will abort the call flow.
3) Otherwise, take the audio stream and send to the speech-to-text engine 313.
4) The speech-to-text engine 313 returns with the text of the translated audio

The speech-to-text engine 313 receives audio stream of data and returns the text of the translated audio. Multiple languages are supported. The recognizer board 314 provides the processing for the microphone 315 and speaker 316. Cloud-based SAM REST API 317 service that receives commands from all SAM voice assistants 330 and stores the updates to the call tree 360.

The main thread 318 runs the SAM voice engine 307. All processed SAM voice events and error logs are stored in the SAM cloud-based events database 344. Due to privacy, only voice events related to SAM are stored in the database 344.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles of the invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A cloud-based activities measuring and monitoring system for the health and well-being of a subscriber comprising:
a platform,
an engagement web in communication with the platform; the engagement web further comprising at least one sensor and at least one interactive health and well-being assistant;
an off-site cloud computing network in communication with the platform and configured to analyze data from the platform and other external sources;
wherein the at least one sensor is configured to collect event data and communicate the event data with the platform; and
wherein the at least one interactive health and well-being assistant is configured to engage with the subscriber, and is configured for two-way communication.

2. The system of claim 1, wherein the platform further comprises an HTTPS-based interface to send and receive data to the cloud computing network.

3. The system of claim 1, wherein the event data includes activities of the subscriber;
wherein the activities may include categories selected from physical, social, cognitive, emotional, and environmental.

4. The system of claim 3, wherein the engagement web is remotely activatable by a secondary party creating a multi-way link between the subscriber and a secondary party

5. The system of claim 4, wherein the secondary party is a caregiver, a health care provider, payor, or another interested party.

6. The system of claim 1, wherein the at least one assistant comprises a microphone and a speaker.

7. The system of claim 6, wherein the speaker is remotely and locally initiated.

8. A method of measuring and monitoring the health and well-being of a subscriber comprising:
distributing an engagement web in a living space, the engagement web comprising at least one sensor and at least one interactive health and well-being assistant having means for two-way communication and comprising a microphone and a speaker;
wherein the at least one sensor is configured to track an event having an alert threshold, the at least one sensor generating event data regarding attributes of the event; the at least one sensor being in communication with the at least one assistant distributed in the living space; and wherein the event data is relative to the alert threshold of the event;
connecting the engagement web to a platform within the living space, wherein the at least one sensor securely communicates event data to the platform; wherein the platform provides local infrastructure management and event data caching;
securely communicating the event data from the platform to a cloud-based operational support system, wherein the operational support system comprises a machine learning process running on a machine readable medium; and
wherein the machine learning process:
compares the event data against the alert threshold;
determines whether the event data exceeds the alert threshold and if the event data exceeds the alert threshold an alert is activated; and
if an alert is activated, the machine learning process communicates the alert to a user, and wherein the alert is further communicated to a call tree.

9. The method of claim 8, wherein the alert threshold comprises a plurality of thresholds.

10. The method of claim 8, wherein the user is selected from the group including the subscriber, a caregiver, a healthcare provider, a payor, or an interested third party.

11. The method of claim 8, wherein the alert threshold is adjustable by the operational support system as a result of the machine learning process, as well as the user.

12. The method of claim 8, wherein the user is a subscriber in the living space and if an alert is activated and communicated to the subscriber, the at least one health and well-being assistant relays a communication message into the living space; wherein the communication message requires a response.

13. The method of claim 12, wherein the communication method is relayed over a land-line, a cell phone, or the at least one interactive health and well-being assistant.

14. The method of claim 12, wherein if the interactive health and well-being assistant does not detect an appropriate response, the operational support system sends a second communication message to another user.

15. The method of claim 12, wherein the machine learning process further uses the response to analyze the well-being of the subscriber.

16. The method of claim 8, wherein the alert is further communicated to a call tree, wherein the call tree is adjustable by the subscriber or another user.

17. The method of claim 8, further comprising determining a routine of a subscriber and creating a baseline of activity.

18. The method of claim 17, wherein the operational support system creates and adjusts the baseline of activity in response to variations in the subscriber's routine.

19. The method of claim 18, wherein the operational support system sets and adjusts the event threshold with predictive analysis.

20. A tangible non-transitory computer readable storage medium having instructions stored thereon that, when executed by a computing device, cause the computing device to perform operations comprising:
receiving event data from a user in a living space based at least in part on information regarding the living space, wherein the event data is based on data collected from at least one sensor in the living space;
analyzing the event data and comparing the event data to positive and negative thresholds for the user's well-being; an event database storing thresholds;
determining if the user's well-being has a positive state or a negative state;
wherein if the user's well-being has a negative state:
initiating a communication with the user in the living space via an assistant;
receiving a response from the user via the assistant;
analyzing voice characteristics of the user based on the response; and
initiating a call tree to communicate with secondary users; wherein if no response is received from the user, then initiating a call tree to communicate with secondary users.
